(19) United States
(12) Patent Application Publication
(10) Pub. No.: US 2016/0084966 A1
(43) Pub. Date: Mar. 24, 2016

(54) METHOD AND DEVICES FOR OUTPUTTING X-RAY INFORMATION STORED IN A MEMORY PHOSPHOR LAYER

(71) Applicant: AGFA HEALTHCARE N.V., Mortsel (BE)

(72) Inventors: Georg REISER, Munich (DE); Stephan MAIR, Augsburg (DE); Malte SCHULZ, Munich (DE); Ralph THOMA, Augsburg (DE)

(73) Assignee: AGFA HEALTHCARE NV, Mortsel (BE)

(21) Appl. No.: 14/784,745

(22) PCT Filed: Apr. 9, 2014
(86) PCT No.: PCT/EP2014/057203

§ 371 Date: Oct. 15, 2015

(30) Foreign Application Priority Data
Apr. 16, 2013 (EP) 13001978.9

(51) Int. Cl. G01T 1/20

(52) U.S. Cl. CPC G01T 1/2014

(57) ABSTRACT

A method and device for reading out X-ray image information stored in a storage phosphor layer with a stimulating light beam includes deflecting the stimulating light beam to alternately move it in a first direction and in a second direction, opposite to the first direction, across the storage phosphor layer. During the movements of the stimulating light beam in the first direction and the second direction, detection emission light emitted by the storage phosphor layer and converting them into corresponding first and second detector signals, respectively. The first and second detector signals are compared with each other. The first and/or second detector signals, which were obtained during the movements of the stimulating light beam across the storage phosphor layer in the first direction and second direction, respectively, are corrected dependent on the results of the comparison.

### CROSS-REFERENCE TO RELATED APPLICATIONS

This application is a 371 National Stage Application of PCT/EP2014/057203, filed Apr. 9, 2014. This application claims the benefit of European Application No. 13001978.9, filed Apr. 16, 2013, which is incorporated by reference herein in its entirety.

### BACKGROUND OF THE INVENTION

1. Field of the Invention

The present invention relates to methods and corresponding devices for reading out X-ray information stored in a storage phosphor layer.

2. Description of the Related Art

The storing of X-rays penetrating an object, for example a patient, as a latent image in a so-called storage phosphor panel constitutes an option for recording X-ray images. In order to read out the latent image, the storage phosphor panel is irradiated with stimulating light and thereby stimulated to emit emission light. The emission light, the intensity of which corresponds to the image stored in the storage phosphor panel, is detected by an optical detector and converted into electrical signals. The electrical signals are further processed, as required, and finally made available for analysis, in particular for medical-diagnostic purposes, by transmitting them to a corresponding output device, such as for example a monitor or a printer.

It is known from the prior art to deflect a stimulating light beam by an oscillating mirror in such a way that the beam is alternately guided in a first direction and in an opposite second direction across the storage phosphor plate. During this process, disturbing artifacts may occur in the images that are composed of the respective obtained detector signals.

### SUMMARY OF THE INVENTION

The problem addressed by preferred embodiments of the present invention is to provide methods and corresponding devices that eliminate or at least to reduce image artifacts in a manner as straightforward and reliable as possible.

The preferred embodiments are achieved by methods and devices, respectively, described below.

In a method according to a first aspect of the solution to the problem, a stimulating light beam, which can stimulate the storage phosphor layer in order to have it emit emission light, is deflected by a deflection element and is thereby alternately moved in a first direction and in a second direction opposite to the first direction across the storage phosphor layer and emission light emitted by the storage phosphor layer during the movements of the stimulating light beam in the first and second direction is detected by a detector and is converted into first and second detector signals, respectively. Preferably, first and second detector signals, which were obtained during the movements of the stimulating light beam in the first and second direction, respectively, are compared with each other and the first and/or second detector signals are corrected dependent on the result of this comparison.

A corresponding device according to the first aspect of the solution comprises: a light source for generating a stimulating light beam, which can stimulate the storage phosphor layer in order to have it emit emission light, a deflection element for deflecting the stimulating light beam in such a way that the beam is alternately moved in a first direction and in a second direction opposite to the first direction across the storage phosphor layer, and a detector for capturing the emission light emitted by the storage phosphor layer during the movements of the stimulating light beam in the first and second direction and for converting the captured emission light into corresponding first and second detector signals, respectively. Preferably, a control unit is provided for processing the first and second detector signals in such a way that first and second detector signals, which were obtained during the movements of the stimulating light beam in the first and second direction, respectively, are compared with each other and the first and/or second detector signals are corrected dependent on the result of this comparison.

In a method according to a second aspect of the solution to the problem, a stimulating light beam, which can stimulate a reference object and the storage phosphor layer in order to have them emit emission light, is deflected by a deflection element and is thereby alternately moved in a first direction and in a second direction opposite to the first direction across the reference object and the storage phosphor layer, respectively, and emission light emitted by the reference object and the storage phosphor layer, respectively, during the movements of the stimulating light beam in the first and second direction is detected by one or more detectors and is converted into corresponding first and second detector signals, respectively. Preferably, first and second detector signals, which were obtained during the movements of the stimulating light beam across the reference object in the first and second direction, respectively, are compared with each other and first and/or second detector signals, which were obtained during the movements of the stimulating light beam across the storage phosphor layer in the first and second direction, respectively, are corrected dependent on the result of this comparison.

A corresponding device according to the second aspect of the solution comprises: a light source for generating a stimulating light beam, which can stimulate a reference object and the storage phosphor layer in order to have them emit emission light, a deflection element for deflecting the stimulating light beam in such a way that it is alternately moved in a first direction and in a second direction opposite to the first direction across the reference object and the storage phosphor layer, respectively, and a detector for detecting the emission light emitted by the reference object and the storage phosphor layer, respectively, during the movements of the stimulating light beam in the first and second direction and for converting the detected emission light into corresponding first and second detector signals, respectively. Preferably, a control unit is provided for processing the first and second detector signals in such a way that first and second detector signals, which were obtained during the movements of the stimulating light beam across the reference object in the first and second direction, respectively, are compared with each other and first and/or second detector signals, which were obtained during the movements of the stimulating light beam across the storage phosphor layer in the first and second direction, respectively, are corrected dependent on the result of this comparison.

The above-mentioned aspects, which represent alternative solutions to the problem, are based upon the common inventive approach which consists in eliminating or at least reducing possible artifacts in the image which is composed of a plurality of first and second detector signals, whereby image information which is comprised in the first and second detector signals which are obtained by scanning the storage phosphor layer and/or a reference object, which comprises e.g. fluorescent markings, at different scan directions, is compared with each other and subsequently, dependent on the result of this comparison, the first and/or second detector signals obtained by scanning the phosphor layer are corrected.

Generally, when deriving an image from the first and second detector signals, a reference is generated between on the one hand a spatial position on the storage phosphor layer and on the other hand the time point at which the emission light is detected at this position or a corresponding detector signal value for this position is generated, respectively. In order to achieve this, different model parameters are used for both directions of movement of the stimulating light beam. This may lead to systematic errors with regard to the pixel time assignment in both directions of movement. This manifests itself in the form of artifacts in the image, inter alia in the form of fringed edges. Thanks to the above-described comparison of the first and second detector signals which are determined from the storage phosphor layer itself or from a reference object, in particular for neighboring lines, information can be derived in a straightforward and reliable way as to what extent first and second detector signal waveforms of neighboring lines deviate from each other as a result of the different direction of movement of the stimulating light beam during the scanning of the storage phosphor layer along both lines. Such deviations can manifest themselves e.g. by the fact that the first and second detector signal courses are shifted relative to one another in the line direction and/or, also in case of substantially unchanged image information, have different signal heights. The first and/or second detector signals, which are obtained during the movement of the stimulating light beam in the first and second direction, respectively, across the storage phosphor plate, can then be corrected with regard to the influences and/or deviations determined during this comparison.

As a result, this eliminates or at least to reduces in a straightforward and reliable way possible artifacts in the image, which is composed of a plurality of first and second detector signals.

Preferably, first and second detector signals are compared with each other with regard to the image information contained therein. With the proviso that the image information of a first line is not substantially different from a neighboring second line of the storage phosphor layer, possibly deviating image information between a first and second detector signal course can allow for reliable determination and correction of any effects of the different scan directions on the read-out image.

In a particularly preferred embodiment, the first and second detector signals are compared with each other by determining a correlation, in particular a correlation function, between the first and second detector signals. Moreover, it is preferred that a possible spatial offset between the first and second detector signals is determined on the basis of the mutual comparison of the first and second detector signals. Alternatively or in addition, the first and/or second detector signals are corrected in such a way that the determined spatial offset is eliminated or at least reduced. Preferably, a correlation of image contents of two lines is performed by dividing the scan line in different areas (“areas of interest”, AOI), whereupon in each area the detector signals for both directions of movement, i.e. the first and second direction, respectively, are compared with each other and the respective spatial shift is determined at which the image information is optimally superimposed. A possible preferred calculation method is the position of the maximum of the cross-correlation function of the line profiles in both directions of movement. The thus determined offset values are used for a corresponding correction of the first and/or second detector signals. Such a correction is also designated as geometric calibration, as in this case the first and second detector signals are related to or converted into a common spatial reference system.

Preferably, a correlation of image contents is performed which—according to the above-described first aspect of the solution—were determined during the read-out of the storage phosphor layer. Alternatively or in addition, it is however also possible to perform a correlation of image contents which—according to the above-described second aspect of the solution—were determined on the basis of a stationary reference object and/or sample which is preferably recorded before each scan of the storage phosphor layer. To that end, preference is given to a fluorescent dye sample as such sample generates, without prior X-ray exposure, a detector signal in the photomultiplier. Optionally, it can be advantageous to additionally take into account possible differences in afterglow behavior between the storage phosphor and the dye used.

The above-illustrated measures contribute—alone or in combination—to eliminating or at least reducing possible artifacts in the obtained image in a straightforward and reliable way.

In a further preferred embodiment, first and second detector signals are compared with each other by determining, in particular estimating, an error profile which reflects deviations between at least a first detector signal and at least a second detector signal with regard to the information contained therein. During this process, the error profile, in particular the estimated error profile, can be subjected to a filtering, whereby the filtering of the error profile, in particular the estimated error profile, allows to preferably isolate an artifact which originates from the fact that the stimulating light beam is alternately moved in the first direction and in the second direction opposite to the first direction across the storage phosphor layer. First and/or second detector signals can subsequently be corrected on the basis of the optionally filtered error profile and the determined artifact, respectively. In a further preferred variant, a second error profile is determined from the first error profile by subjecting the first error profile to a filtering, in which image information is eliminated.

The above-illustrated measures also contribute—alone or in combination—to eliminating or at least reducing possible artifacts in the obtained image in a straightforward and reliable way.

The illustrated embodiments represent a phenomenological correction of differences, which are due to opposite directions of movement of the stimulating light beam, in the detector signals, whereby lines, preferably neighboring lines, are compared with each other on the basis of the image data contained therein. All system-dependent differences of the scan process in both directions of movement of the stimulating light beam ultimately manifest themselves in the obtained image as an artificial 2^{nd} order period in the image signal along the slow scan direction, i.e. the forward feed direction of the image plate (so-called “2^{nd} order banding”). In the outlined phenomenological approach, the physical causes responsible for this are not assumed as known a priori, but errors and artifacts, respectively, are determined and corrected on the basis of the image data themselves. Preferably, the following steps are hereby performed:
calculating or estimating an error profile on the basis of the measured image data;
optionally filtering the error profile in order to obtain a more precise isolation of the artifact;
correction of the error on the basis of the optionally filtered error profile.

These steps can be represented as follows in a preferred concrete conversion: as error profile F(x, y), for each pixel firstly the relative deviation of its value P(x, y) from the values P(x, y−1) and P(x, y+1) is calculated on the basis of the values interpolated from the neighboring lines (i.e. lines having the respective other direction of movement of the stimulating light beam). In the simplest case of a linear interpolation, this results in:

$$F ( x , y ) = \frac{2 \cdot P ( x , y )}{P ( x , y - 1 ) + P ( x , y + 1 )}$$

Apart from the error to be corrected, the error profile thus determined further comprises image information, which in the example above of a linear interpolation represents precisely the non-linear parts of the signal courses. However, since such deviations occur solely at short length scales (i.e. at high image frequencies), they can now be eliminated in the second step by a low-pass filter T, for example by a so-called Running-Average Filter or a Median Filter. The error values in both oscillation directions are systematically different and hence are to be taken into account separately, thus:

F_{trace}→T(F_{trace})

F_{retrace}→T(F_{retrace}).

wherein the indices “trace” and “retrace” relate to lines of the first and second direction, respectively, of the stimulating light beam, in particular to the forward and backward oscillation of the deflection mirror.

The error profile thus calculated indicates artificial relative deviations of the signal level from the respective other oscillation direction. For the purpose of the correction, the signal levels are preferably adapted to one another:

$$P ( x , y ) \to \frac{P ( x , y )}{\sqrt{F ( x , y )}} .$$

Here, a correspondingly modified unilateral application to only one direction of oscillation can also be considered.

In a method for reading out X-ray image information stored in a storage phosphor layer which can be applied alternatively or in addition, a stimulating light beam, which can stimulate the storage phosphor layer in order to have it emit emission light, is deflected by a deflection element and is thereby alternately moved in a first direction and in a second direction opposite to the first direction across the storage phosphor layer and emission light which is emitted by the storage phosphor layer during the movements of the stimulating light beam in the first and second direction is detected by a detector and is converted into corresponding first and second detector signals, respectively. Preferably, first and/or second detector signals are hereby corrected with regard to influences which originate from the fact that the stimulating light beam is alternately moved in the first direction and in the second direction opposite to the first direction across the storage phosphor layer.

A corresponding device for reading out X-ray image information stored in a storage phosphor layer comprises: a light source for generating a stimulating light beam, which can stimulate the storage phosphor layer in order to have it emit emission light, a deflection element for deflecting the stimulating light beam in such a way that the beam is alternately moved in a first direction and in a second direction opposite to the first direction across the storage phosphor layer, and a detector for detecting the emission light emitted by the storage phosphor layer during the movements of the stimulating light beam in the first and second direction and for converting the detected emission light into corresponding first and second detector signals, respectively. Preferably, a control unit is further provided which processes the first and second detector signals in such a way that first and/or second detector signals are corrected with regard to influences which originate from the fact that the stimulating light beam is alternately moved in the first direction and in the second direction opposite to the first direction across the storage phosphor layer. Any artifacts are hereby eliminated or at least reduced.

This solution is based on the approach of correcting the image which is composed of a plurality of first and second detector signals with regard to possible artifacts which originate from the use of the first and second detector signals obtained in opposite directions of movement of the stimulating light beam. This process allows preferably to reduce or eliminate artifacts which are due to the so-called destructive reading-out process, in which the X-ray information stored in the storage phosphor layer is erased at least partially when irradiated with stimulating light, and/or to afterglowing of the storage phosphor after the irradiation with the stimulating light beam and which manifest themselves inter alia by the fact that edges which run perpendicular to the first and second direction in the stored X-ray image appear as fringed edges in the read-out image, which in this case represent an artifact. Alternatively or in addition, artifacts can be reduced or eliminated which are due to the fact that the sensitivity of the device, in particular of the detector, to the emission light to be detected depends on the height and/or the course of, in particular for the same line, the respective previously obtained first and second detector signals, respectively. For example, the sensitivity of the detector in the first direction can be reduced temporarily if immediately before that a “light” area of the storage phosphor layer emits emission light having a relatively high intensity in the same line so that the detector is “shaded” temporarily and only shows full sensitivity again after a certain lapse of time. Hence, for spatial areas that are located in the direction of the first direction, when viewed from the light area, detector signals having a reduced signal height are obtained. If the light area of the storage phosphor layer is subsequently sampled with the stimulating light beam in the opposite second direction, then the sensitivity of the detector and the corresponding second detector signals are also reduced temporarily, at least for spatial areas which are located in the direction of the second direction, when viewed from the light area. As a result, in the obtained read-out image, which is composed of a plurality of first and second detector signals, structures on both sides of such a light area appear alternately, i.e. from one line to the next one, with different lightness, which represents an artifact in the present case.

Altogether, the above-described solution, which can be applied alternatively or in addition, also allows to eliminate or at least to reduce in a straightforward and reliable way possible artifacts in the image composed of a plurality of first and second detector signals.

Preferably, first and/or second detector signals are corrected while taking into account at least one point image function, which is characteristic for a course of first or second detector signals along the first and second direction, respectively, in the case of a point-like stimulation of the storage phosphor layer. Based upon the destructive reading-out process and the afterglow of the storage phosphor, the point image function of the imaging system, which image-wise reproduces the stimulated emission light on the detector, can be offset relative to the respective position of the stimulating light beam, e.g. laser spot, on the storage phosphor layer and moreover have a slightly asymmetrically formed peak. As a result of the different directions of movement of the laser spot on the storage phosphor layer, different point image functions occur in the first and second direction, which lead, inter alia, to the formation of fringed edges. By using the relevant point image function for the first and/or second direction, the course, in particular the position and/or height, of the first and/or second detector signals is corrected in a straightforward way so that such artifacts do not occur anymore or their number is reduced.

It is furthermore preferred that the at least one point image function is determined before reading out the storage phosphor layer. As a result, the at least one point image function is already available during the reading-out process and can be taken into account in the correction without having to be first determined during the reading-out process. Alternatively or in addition, the point image function is determined by measuring, for example on a storage phosphor layer that is exposed to a certain sample, or by a numerical simulation of the reading-out process. A measurement allows a precise and straightforward determination of the at least one point image function. A numerical simulation allows determining the point image function in a straightforward and secure way without requiring an additional measurement. Overall, the above-mentioned embodiments contribute—alone or in combination—to eliminate or at least to reduce possible artifacts in a straightforward and reliable way. Alternatively, however, it is also possible to determine the point image function only after reading out the storage phosphor layer and to apply an intermediate storage of the detector signals thereby obtained.

A further embodiment provides that first and/or second detector signals are subjected to a so-called deconvolution, wherein corrected first and second detector signals are obtained from the first and second detector signals, respectively, and the respective characteristic point image function. The deconvolution can e.g. be realized using a Wiener filter. Preferably, corrected first detector signals are hereby determined from first detector signals and a first point image function, which characterizes the imaging system for the case where the stimulating light beam is moved in the first direction across the storage phosphor layer. Alternatively or in addition, corrected second detector signals are determined from second detector signals and a second point image function, which characterizes the imaging system for the case where the stimulating light beam is moved in the second direction across the storage phosphor layer. These embodiments are based upon the approach that the first and second detector signals are obtained through a convolution of the spatial distribution of color centers stimulated in the storage phosphor layer with the first and second point image function, respectively, of the imaging system. Hence, a deconvolution, which reverses the convolution process, provides corrected first and second detector signals, which in this case correspond to the “real” intensity curve of the emission light, in which influences due to the scanning in different directions are eliminated, along a line on the storage phosphor layer. This embodiment also contributes further to eliminate or at least to reduce possible artifacts in a particularly straightforward and reliable way.

Alternatively or in addition, first and/or second detector signals are corrected through a filtering, in which a filter value, which is proportional to the second derivation of the first and second detector signals, respectively, is computed with the first and second detector signals, respectively, in particular is added to the first and second detector signals, respectively, or is subtracted from the first and second detector signals, respectively. This embodiment is based upon the unexpected finding that deviations in the signal course seem to be proportional to the curvature, i.e. to the second derivation, of the signal. A corresponding filter has the following form:

$$P ( x , y ) \to P ( x , y ) + c \cdot ED \cdot \vert \frac{{d}^{2} P ( x , y )}{d {x}^{2}} \vert ,$$

wherein P(x, y) represents the pixel value, i.e. the height of the first and second detector signal, at the location (x, y) on the storage phosphor layer and c represents a constant filter parameter. The parameter ED can have values±1, depending on whether the signal at the respective pixel position is temporally rising or falling. In case of the filter value c·ED·|d²P (x, y)/dx²|, it is preferably an empirically determined filter value. This embodiment contributes also further to eliminate or at least to reduce possible artifacts in a particularly straightforward and reliable way.

Alternatively or in addition, it can be advantageous to correct first and/or second detector signals by filtering, in which a filter value, which is proportional to the n^{th} derivation of the first and second detector signals, respectively, is computed with the first and second detector signals, respectively, in particular is added to the first and second detector signals, respectively, or is subtracted from the first and second detector signals, respectively, wherein n is larger than two.

In order to enhance the noise behavior, it can be advantageous to calculate the second derivation on the basis of a smoothed signal {P(x, y)}. In this case, the filter value is proportional to the second derivation of, respectively, the smoothed first and second detector signals |d² {P(x,y)}/dx²|.

Preferably, first and/or second detector signals are corrected for the emission light by taking into account a sensitivity of the device, in particular of the detector, which is dependent on the movement of the stimulating light beam in the first and second direction, respectively. In this case, it is preferred that the sensitivity of the device, in particular of the detector, is dependent on the respective position of the stimulating light beam on the storage phosphor layer. Alternatively or in addition, the sensitivity of the device during the movement of the stimulating light beam in the first and second direction is determined for different positions of the stimulating light beam on the storage phosphor layer. Preferably, the determination of the sensitivity of the device for a position of the stimulating light beam on the storage phosphor layer takes into account at least a part of the first and second detector signal, respectively, which is obtained during the movement of the stimulating light beam in the first and second direction, respectively, towards this position.

In the above-described embodiments, the first and second detector signals generated by the detector are preferably corrected by taking into account the non-linearity of the sensitivity of the system, in particular of the detector, such as e.g. of a photomultiplier (PMT), and/or the previous detector signal course. This allows taking into account possible changes of the PMT sensitivity during a scan, which is dependent on the preceding course of the signal during the scan and can be significantly different in the first and second direction of the stimulating light beam. This also contributes to eliminate or at least to reduce possible artifacts in the read-out image in a straightforward and reliable way.

For the purpose of the correction, the respective current PMT sensitivity loss during a scan can be determined and compensated by means of a model. To that end, first a differential equation for the PMT sensitivity is made up, which is subsequently integrated during the scan on the basis of the measured signal course by analytical or numerical methods, for example in the Euler method. A model equation can preferably be represented as follows:

$$\frac{d S ( t )}{d t} = ( 1 - S ( t ) ) \cdot {k}_{1} - {LPV}_{cor} ( t ) \cdot {k}_{2}$$

wherein dS(t)/dt represents the change of the PMT sensitivity S (t) after the time t, (1−S(t)), k₁ represents the recovery of the PMT sensitivity with a time constant k₁ and LPV_{cor}(t) k₂ represents the decrease of the PMT sensitivity due to incident light with a time constant k₂.

Additional advantages, features and possible applications of the present invention are specified in the following description in the context of the figures. The drawings show:

### BRIEF DESCRIPTION OF THE DRAWINGS

FIG. 1 is a schematic representation of an example of a device for reading out storage phosphor layers.

FIG. 2 is an example illustrating the function of the deflection element in a schematic side view.

FIG. 3 is an example of a typical course of the deflected stimulating light beam on the storage phosphor layer.

FIG. 4 is an example of the course of a first and second detector signal.

FIG. 5 is an example of the course of a first and second point image function.

### DETAILED DESCRIPTION OF THE PREFERRED EMBODIMENTS

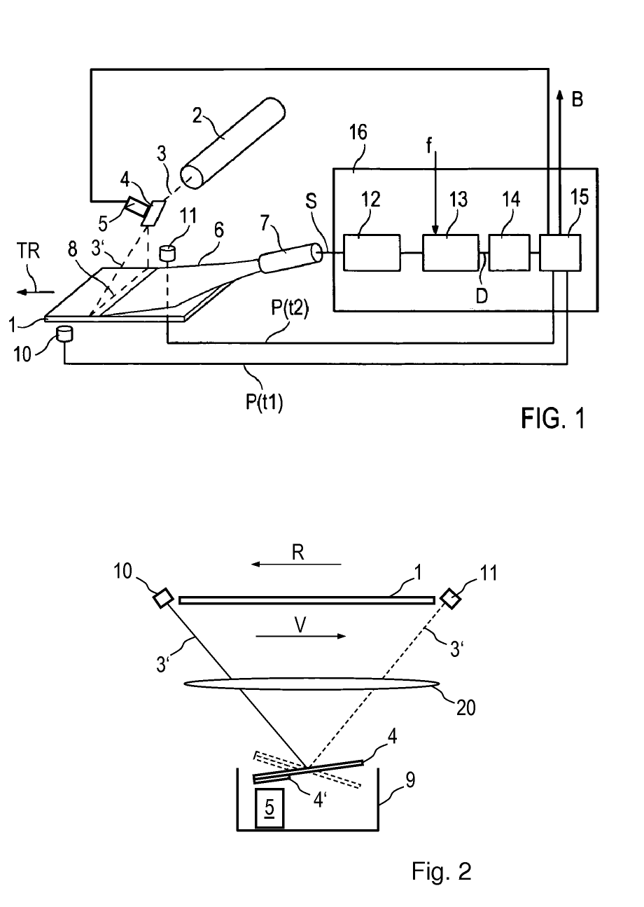

FIG. 1 shows a device for reading out a storage phosphor layer 1. A laser 2 generates a stimulating light beam 3 that is deflected by a deflection element 4 in such a way that the stimulating light beam moves along a line 8 across the storage phosphor layer 1 to be read out. The deflection element 4 has a reflecting area, in particular in the form of a mirror, which is made to oscillate by a driver 5.

During the movement of the deflected stimulating light beam 3′ across the storage phosphor layer 1, this storage phosphor layer emits emission light depending on the X-ray information stored therein, which emission light is collected by an optical collection device 6, for example a PMMA light collector, an optical fiber bundle or a suitable mirror device, and detected by an optical detector 7, preferably a photomultiplier (PMT), and is thereby converted into a corresponding detector signal S.

The detector signal S is supplied to a processing device 16, in which image signal values B for individual image pixels of the read out X-ray image are derived. If the read out line 8 is, for example, composed of 1000 image pixels, then 1000 corresponding image signal values B are derived from the detector signal S that was obtained during the reading out of the line 8.

The transport of the storage phosphor layer 1 in the transport direction TR (the so-called slow scan direction) by a transport device (not shown) has the effect that individual lines 8 of the storage phosphor layer 1 are successively read out, and a two-dimensional X-ray image is thereby obtained that is composed of individual image pixels with respectively one associated image signal value B. If the number of lines 8 read out in the transport direction TR is, for example, 1500, then, with respectively 1000 image pixels per line 8 for the read-out X-ray image, a total of 1500 times 1000 image pixels is obtained with respectively one associated image signal value B.

In principle it is also possible to support the storage phosphor layer 1 in a stationary manner and to move the remaining components, in particular the laser 2, the deflection element 4, the collecting device 6 and the detector 7, relative to the storage phosphor layer 1.

The detector signal S is initially filtered in a low-pass filter 12, wherein high-frequency components of the detector signal S, in particular noise components, are eliminated. The filtered detector signal S is then supplied to an analog-digital converter 13 and sampled there at a sampling frequency f, wherein during every sampling process a detector signal D is obtained in respective digital units. After intermediate buffering in memory 14, the image signal values B are calculated in a control unit 15 from the detector signal values D.

The shown device further comprises two detectors 10 and 11, which are provided on both sides of the storage phosphor layer 1 in such a way that the deflected stimulating light beam 3′ can impinge on them before or after it scans or has scanned, respectively, across the storage phosphor layer 1 along the line 8. When the stimulating light beam 3 is deflected in the direction of the line 8 by the deflection element 4, then it passes, before the actual sampling of the line 8, first past the first detector 10 and subsequently past the second detector 11. The light of the deflected stimulating light beam 3′ is thereby captured by both light-sensitive detectors 10 and 11 and converted into corresponding electrical signals P(t1) and P(t2) at the time points t1 and t2, respectively, and forwarded to the control unit 15 of the processing device 16.

The control unit 15 is connected with the driver 5 for driving the deflection element 4 and controls the deflection element in such a manner that the deflection element 4 is only actively driven, through the release of drive energy from the driver 5, in the case when or after the deflected stimulating light beam 3′ has reached a certain direction and/or position. In the example shown, the deflected stimulating light beam 3′ scans across at least one of the detectors 10 and 11, whereupon the detector transmits an electrical pulse to the control unit 15 that—if applicable, after a presettable time delay—controls the driver 5 in such a manner that the driver temporarily releases drive energy, in particular in form of a drive energy pulse, to the oscillating deflection element 4 and thereby maintains the deflection element's oscillation, preferably in the range of a resonance frequency of the deflection element 4.

FIG. 2 shows an example illustrating the function of the deflection element in a schematic side view. The deflection element 4 comprises a reflecting area, which, for example by a torsion spring not shown, is mounted in a housing 9 in such a way that any displacement of the deflection element 4 about a center axis running perpendicular to the drawing plan generates a restoring force, which displaces the deflection element 4 in the opposite direction (see deflection element represented by a dotted line).

The displacement of the deflection element 4 is preferably driven by an electromagnet 5, which, by applying an electrical voltage and thus generating a current flow, creates a magnetic field which acts on a magnetic element 4′ located at the deflection element 4. Depending on the material of the magnetic element 4′, it can either be attracted by the electromagnet 5 or be repulsed by it or solely be attracted by it. The former applies if the magnetic element comprises permanently magnetic substances. The latter applies when using a ferromagnetic material without permanent magnetization.

In order to move the deflection element 4 from its standby position, first into an oscillating state, voltage pulses of a predetermined duration and frequency are continuously applied to the electromagnet 5, whereby the oscillation amplitude of the deflection element 4 finally increases to a level such that the deflected stimulating light beam 3′ runs across the width of the storage phosphor layer 1 to be sampled and thereby particularly also impinges on the first detector 10 and second detector 11, respectively.

In the example shown, an optical device 20, so-called post-scan optics, is provided between the deflection element 4 and the storage phosphor layer 1, wherein the optical device 20, on the one hand, focuses the deflected stimulating light beam 3′ onto the storage phosphor layer 1 and, on the other hand, converts its radial movement in a linear movement along the line 8 (see FIG. 1) on the storage phosphor layer 1. Alternatively or in addition to post-scan optics, it is also possible to use so-called variofocal optics, which is disposed between the laser 2 and the deflection element 4 (so-called pre-scan optics) and forms the laser beam 3 in such a way that, after having been displaced by the deflection element 4 along the line 8, it is uniformly focused onto the storage phosphor layer 1. In this case, post-scan optics can be omitted. Principally, however, it is also possible to omit the complete optical device 20 and to calculate associated distortions from the obtained X-ray image, for example by using information relating to the behavior of the stimulating light beam as determined before the reading out.

The above-described measures allow to excite the deflection element 4 to oscillate about its center axis in such a way that the stimulating light beam 3 impinging on the reflecting area (see FIG. 1) is deflected in such a way that it alternately scans across the storage phosphor layer 1 in a first direction V, also designated as “Trace”, and in a second direction R opposite to the first direction V, also designated as “Retrace”, thereby stimulating it in order to have it emit emission light. As the storage phosphor layer 1 is hereby sampled, i.e. read out, both in the Trace direction and in the Retrace direction, this type of reading out can also be designated as bidirectional scanning.

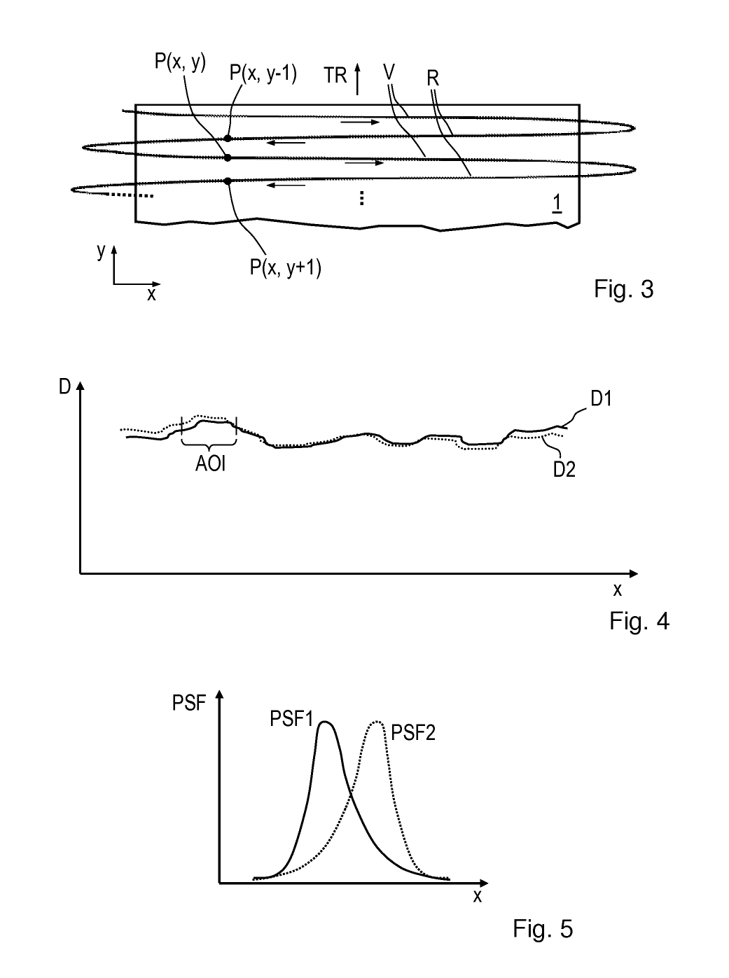

FIG. 3 shows an example of a typical course of the deflected stimulating light beam 3′ on the storage phosphor layer 1. Due to the oscillation movement of the deflection element 4, the velocity of the deflected stimulating light beam 3′ decreases towards the edges of the storage phosphor layer 1, which, in case of a constant forward feed speed of the storage phosphor layer in the transport direction TR, has the effect that the path of the stimulating light beam 3′ on the storage phosphor layer 1 is rather a flat sinusoidal path than an exactly linear zigzag movement.

In the example shown in FIG. 3, the distance between the individual lines sampled in the Trace direction V and the Retrace direction R of the storage phosphor layer 1 is shown very large for the sake of clarity. In reality, however, the lines are in such close proximity of each other that the overall area of the storage phosphor layer 1 is read out in a substantially gapless way.

The images obtained by bidirectional scanning can comprise disturbing artifacts, such as e.g. the so-called 2^{nd} order banding and fringed edges, which can strongly impair the diagnostic significance or usability of the obtained images. Thanks to the different aspects and embodiments of the inventive solutions, such artifacts are eliminated or at least reduced by taking into account and eliminating or reducing, in particular, effects which are due to a sensitivity loss of the PMT at high-dose recordings, a pre-reading-out offset caused by the destructive reading out and an asymmetrical point image function, a possible asymmetrical movement of the laser spot across the storage phosphor layer and an afterglow of the storage phosphor. This will be exemplified hereinafter in greater detail.

FIG. 4 shows an example of the course of a first detector signal D1 and a second detector signal D2, which were obtained during the scan of neighboring lines of the storage phosphor layer 1 in the Trace direction R and the Retrace direction V, respectively, along the so-called fast scan direction x.

As can be seen in the example, the course of the first detector signal D1 systematically deviates from the course of the second detector signal D2, although the image contents of the neighboring lines of the storage phosphor layer are substantially equal. In the case shown, the spatial course of the second detector signals D2, compared to the first detector signals D1, is shifted by a certain spatial offset in the Retrace direction R (see FIG. 3). These deviations caused by the different directions of movement V and R of the stimulating light beam 3′ lead, inter alia, to fringed edges in the overall image, which is composed of a plurality of first and second detector signals D1 and D2.

For the purpose of correcting the systematical errors, a correlation of image contents of both detector signals D1 and D2 is preferably carried out. To that end, the respective course of the detector signals D1 and D2 is divided into multiple AOI areas, whereby for the sake of clarity only one such area is delineated in FIG. 4. In each of these AOI areas, the detector signals D1 and D2 of both oscillation directions V and R are compared with each other and a spatial shifting is determined at which the image contents are superimposed. The shifting is preferably determined by determining a cross-correlation function of the profiles of the first and second detector signals D1 and D2. The thus determined shifting allows to correct correspondingly, i.e. to spatially shift, the first detector signal D1 and/or the second detector signal D2.

In the above-described embodiments, the correction of the first and second detector signals D1 and D2 is carried out by means of a comparison, in particular a correlation, of image contents of these detector signals D1 and D2. Alternatively, however, it is also possible to sample a reference object before reading out the storage phosphor plate and to determine correction values, in particular a shift, by means of a comparison, in particular a correlation, of the thereby determined first and second detector signals D1 and D2, which correction values subsequently allow to correct the first and second detector signals obtained when reading out the storage phosphor layer. A preferred reference object is a fluorescent dye sample, as such sample also emits emission light without having to be exposed to X-rays, i.e. when being stimulated with the stimulating light beam. The reference object itself preferably has a form and/or size that correspond(s) to the storage phosphor layer 1 depicted in the FIGS. 1 to 3. The handling of the reference object during the reading out of the emission light emitted by it is therefore identical to the handling of the storage phosphor layer 1. For the sake of clarity, no additional representation of a reference object is shown. In the case of the above-described alternative, the storage phosphor layer 1 depicted in the FIGS. 1 to 3 can instead be considered as reference object. Preferably, the reference object comprises a non-fluorescent base onto or into which a fluorescent reference sample, for example a dye, has been applied.

Furthermore, it can be derived from the course of the first and second detector signal D1 and D2 depicted in FIG. 4 that these detector signals also deviate from each other in height, in particular in the edge areas. As a result, an image composed of a plurality of corresponding first and second detector signals shows periodic fluctuations of lightness from line to line in the edge area.

In order to reduce or eliminate such artifacts, the intensity of the stimulating light beam is preferably varied during the scan in the Trace direction V and the Retrace direction R as a function of the respective current position of the beam on the storage phosphor layer. Preferably, the power of the light source, in particular the laser 2, is thereby increased temporarily after the movement of direction Trace V has been reversed to Retrace R, so that during the movement of the stimulating light beam 3′ in the area of the right edge of the storage phosphor layer 1—as shown in the example depicted in FIG. 3—the intensity of the stimulating light beam 3′ is increased and correspondingly higher second detector signals D2 for the right edge area are obtained.

Alternatively or in addition, the laser power is increased temporarily after the movement of direction Retrace R has been reversed to Trace V, so that during the movement of the stimulating light beam 3′ in the area of the left edge of the storage phosphor layer 1—as shown in the example depicted in FIG. 3—the intensity of the stimulating light beam 3′ is increased and correspondingly higher second detector signals D1 for the left edge area are obtained.

Due to the destructive reading out process and the afterglow of the storage phosphor, the point image function (PSF) of the imaging system is offset relative to the position of the laser spot on the storage phosphor layer and moreover has a slightly asymmetrically formed peak. The different direction of movement of the laser spot on the storage phosphor layer 1 leads to point image functions that differ depending on the oscillation direction of the deflection element 4. This also contributions to the occurrence of, inter alia, fringed edges.

FIG. 5 shows an example of the course of a first point image function PSF1 and a second point image function PSF2 along the fast scan direction x. The first point image function PSF1 reflects the spatial course of the first detector signal, which is obtained when the storage phosphor layer 1 is subjected to a point-wise irradiation with a stimulating light beam 3′ which is moved in the Trace direction V. The same applies to the second point image function PSF2. As can be seen in the example, both point image functions PSF1 and PSF2 have an asymmetrical course. Moreover, the centroids and peaks of both point image functions PSF1 and PSF2 are offset relative to one another.

Both point image functions PSF1 and PSF2 can be determined a priori, for example by measuring them on a storage phosphor layer or by a numerical simulation of the reading out process. On the basis of the a priori determined point image functions PSF1 and PSF2, a deconvolution, for example by a Wiener filter, can then be applied to the first detector signals D1 and second detector signals D2, which manifests itself in the resulting image, which is composed of a plurality of first and second detector signals D1 and D2, as symmetrized edge contours so that the above-described artifacts in the form of fringed edges are eliminated from the image.

As an alternative to the use of point image functions, the edge contours in the image can also be symmetrized by an empirical filter, whereby it is preferably assumed that deviations in the course of the detector signal are proportional to the curvature, i.e. to the second derivation, of the signal. In order to enhance the noise behavior, it can be advantageous to calculate the second derivation on the basis of a smoothed signal.

The PMT sensitivity can vary during the scan and generally depends on the preceding course of the signal. As the preceding course can be significantly different for both directions of oscillation, image artifacts occur under certain conditions. For the purpose of the correction, the respective current PMT sensitivity loss during the scan can be determined and compensated by means of a model. To that end, first a differential equation for the PMT sensitivity is made up, which is subsequently integrated on the basis of the measured signal course, i.e. the course of the first detector signals D1 and the second detector signals D2, by analytical or numerical methods (for example in the Euler method) during the scan.

Alternatively or in addition, it is also advantageous to carry out a so-called phenomenological correction of the first detector signals D1 and/or the second detector signals D2 by mutually comparing the courses of the first detector signals D1 and the second detector signals D2, which are obtained at different directions of movement. This approach is based on the finding that, due to both different directions of movement of the stimulating light beam 3′, all system-dependent differences of the scan process manifest themselves in the obtained image in the form of an artificial 2^{nd} order period along the slow scan direction TR of the storage phosphor layer 1 (so-called “2^{nd} order banding”). In a phenomenological approach, the physical causes responsible for the above finding are not assumed as known a priori and hence the errors are estimated and corrected on the basis of the image data themselves, which are obtained in the first and second detector signals, by determining or estimating an error profile from the measured image data, by optionally filtering the error profile in order to achieve a more precise isolation of the artifact and finally by correcting the error on the basis of the filtered error profile.

A preferred conversion of this approach is discussed hereinafter in greater detail with reference to FIG. 3.

As error profile F(x, y), for each pixel having the coordinates x and y, a relative deviation of its value P(x, y) from the values P(x, y−1) and P(x, y+1) interpolated from the neighboring lines (i.e. lines sampled in the opposite direction of movement) is calculated. In the example shown, the value P(x, y) of the delineated pixel corresponds to the height of the first detector signal D1 at the position (x, y), whereas the values P(x, y−1) and P(x, y+1) of the delineated neighboring pixels correspond to the height of the second detector signal D2 at the position (x, y−1) and (x, y+1), respectively.

In case of a linear interpolation, the following equation results for the error profile F(x, y):

$$F ( x , y ) = \frac{2 \cdot P ( x , y )}{P ( x , y - 1 ) + P ( x , y + 1 )} .$$

Apart from the error to be corrected, the thus determined error profile F(x, y) also comprises image information. In the above example of a linear interpolation, this information represents precisely the non-linear parts of the signal courses. However, as such deviations only occur at short length scales (i.e. at high position spatial frequencies), they can preferably be eliminated in a second step by a low-pass filter T, for example by a so-called Running-Average Filter or a Median Filter. The error values in both oscillation directions are systematically different and hence are preferably taken into account separately.

The thus calculated error profile indicates artificial relative deviations of the respective signal level, e.g. of the course of the first detector signal, from the respective other movement of direction, e.g. from the course of the second detector signal. For the purpose of correcting the artifacts, the first and second signal levels are adapted to one another. Preferably, the values P(x, y) of the pixels at the positions (x, y) are hereby divided by the error profile F(x, y) determined for the respective position (x, y).

Preferably, this process is applied both to the values P(x, y) of the first detector signals D1 and to the values P(x, y) of the second detector signals D2. Alternatively, however, it is also possible to apply a correspondingly modified error profile only to the values P(x, y) of one of both detector signals D1 or D2.

1-12. (canceled)

13. A method for reading out X-ray image information stored in a storage phosphor layer, the method comprising the steps of:
deflecting a stimulating light beam, which stimulates the storage phosphor layer to cause the storage phosphor layer to emit emission light, with a deflector to alternately move the stimulating light beam in a first direction and in a second direction, opposite to the first direction, across the storage phosphor layer;
during movements of the stimulating light beam in the first direction and in the second direction, detecting the emission light emitted by the storage phosphor layer with a detector and converting the detected emission light into a first detector signal and a second detector signal, respectively;
comparing the first detector signal and the second detector signal, which were obtained during the movements of the stimulating light beam in the first and second direction, respectively, with each other; and
correcting the first detector signal and/or the second detector signal dependent on a result of the step of comparing.

14. A method for reading out X-ray image information stored in a storage phosphor layer, the method comprising the steps of:
deflecting a stimulating light beam, which stimulates a reference object and the storage phosphor layer to cause the reference object and the storage phosphor layer to emit emission light, with a deflector to alternately move the stimulating light beam in a first direction and in a second direction, opposite to the first direction, across the reference object and the storage phosphor layer, respectively;
during movements of the stimulating light beam in the first direction and in the second direction, detecting the emission light emitted by the reference object and the storage phosphor layer with a detector and converting the detected emission light into a first detector signal and a second detector signal, respectively;
comparing the first detector signal and the second detector signal, which were obtained during the movements of the stimulating light beam across the reference object, in the first direction and in the second direction, respectively, with each other; and
correcting the first detector signal and/or the second detector signal, which were obtained during the movements of the stimulating light beam across the storage phosphor layer in the first direction and the second direction, respectively, dependent on a result of the step of comparing.

15. The method according to claim 13, wherein the first detector signal and the second detector signal are compared with each other with regard to image information contained therein.

16. The method according to claim 13, wherein the first detector signal and the second detector signal are compared with each other by determining a correlation function between the first detector signal and the second detector signal.

17. The method according to claim 13, further comprising the step of determining whether a spatial offset exists between the first detector signal and the second detector signal based on a mutual comparison of the first detector signal and the second detector signal.

18. The method according to claim 17, wherein the first detector signal and/or the second detector signal is corrected to eliminate or reduce the spatial offset.

19. The method according to claim 13, wherein the first detector signal and the second detector signal are compared with each other by determining or estimating an error profile, which reflects deviations between at least one first detector signal and at least one second detector signal with regard to information contained therein.

20. The method according to claim 19, further comprising the step of filtering the error profile.

21. The method according to claim 20, wherein the step of filtering the error profile isolates an artifact capable of being produced by the stimulating light beam being alternately moved in the first direction and in the second direction, opposite to the first direction, across the storage phosphor layer.

22. The method according to claim 20, wherein the first detector signal and/or the second detector signal is corrected based on the filtered error profile or the determined artifact, respectively.

23. A device for reading out X-ray image information stored in a storage phosphor layer, the device comprising:
a light source that generates a stimulating light beam, which stimulates a storage phosphor layer, to cause the storage phosphor layer to emit emission light;
a deflector that deflects the stimulating light beam to alternately move the stimulating light beam in a first direction and in a second direction, opposite to the first direction, across the storage phosphor layer;
a detector that captures the emission light emitted by the storage phosphor layer during movements of the stimulating light beam in the first direction and in the second direction, and that converts the captured emission light into corresponding first and second detector signals, respectively;
a controller that performs a comparison of the first detector signal and the second detector signal to each other and that corrects the first detector signal and/or the second detector signal dependent on a result of the comparison.

24. A device for reading out X-ray image information stored in a storage phosphor layer, the device comprising:
a light source that generates a stimulating light beam, which stimulates a reference object and a storage phosphor layer, to cause the reference object and the storage phosphor layer to emit emission light;
a deflector that deflects the stimulating light beam to alternately move the stimulating light beam in a first direction and in a second direction, opposite to the first direction, across the reference object and the storage phosphor layer, respectively;
a detector that captures the emission light emitted by the storage phosphor layer and the reference object during movements of the stimulating light beam in the first direction and in the second direction and that converts the captured emission light into corresponding first and second detector signals, respectively;
a controller that performs a comparison of the first detector signal and the second detector signal, which were obtained during movements of the stimulating light beam across the reference object in the first direction and in the second direction, respectively to each other, and that corrects the first detector signal and/or the second detector signal, which were obtained during movements of the stimulating light beam across the storage phosphor layer in the first direction and in the second direction, respectively, to each other dependent on a result of the comparison.

25. The method according to claim 14, wherein the first detector signal and the second detector signal are compared with each other with regard to image information contained therein.

26. The method according to claim 14, wherein the first detector signal and the second detector signal are compared with each other by determining a correlation function between the first detector signal and the second detector signal.

27. The method according to claim 14, further comprising the step of determining whether a spatial offset exists between the first detector signal and the second detector signal based on a mutual comparison of the first detector signal and the second detector signal.

28. The method according to claim 27, wherein the first detector signal and/or the second detector signal is corrected to eliminate or reduce the spatial offset.

29. The method according to claim 14, wherein the first detector signal and the second detector signal are compared with each other by determining or estimating an error profile, which reflects deviations between at least one first detector signal and at least one second detector signal with regard to information contained therein.

30. The method according to claim 29, further comprising the step of filtering the error profile.

31. The method according to claim 30, wherein the step of filtering the error profile isolates an artifact capable of being produced by the stimulating light beam being alternately moved in the first direction and in the second direction, opposite to the first direction, across the storage phosphor layer.

32. The method according to claim 30, wherein the first detector signal and/or the second detector signal is corrected based on the filtered error profile or the determined artifact, respectively.
